(19) United States
(12) Patent Application Publication
(10) Pub. No.: US 2004/0178604 A1
(43) Pub. Date: Sep. 16, 2004

(54) Foldable bike

(76) Inventor: Pei-Chuan Ma, Taipei (TW)

Correspondence Address: Pei-Chuan Ma, PO Box 82-144, Taipei, TW

(21) Appl. No.: 10/383,722

(22) Filed: Mar. 10, 2003

(51) Int. Cl. B62K 1/00

(52) U.S. Cl. 280/278

(57) ABSTRACT

A foldable bike includes a head tube, a seat pole, and a seat stay; a head tube with a stem being provided at the top of the head tube, a bracket provided to the head tube to connect to a rising crossbar, another bracket being provided to the seat stay to connect to the descending seat stay, both of the crossbar and the seat stay expanding outwardly by means of the brackets to constitute riding position together with a hydraulic cylinder connected to the head tube and the seat pole, and an absorber provided between the seat pole and the seat stay, or both of the seat pole and the seat stay being folded forwardly with the respective bracket as the support to facilitate storage or handling when the bike is not used.

### BACKGROUND OF THE INVENTION

(a) Field of the Invention

The present invention is related to a foldable bike, and more particularly, to one that facilitates storage or handling of the bike by fast and easy folding to reduce the size of the bike.

(b) Description of the Prior Art

The bike has been always a very popular and simple transportation means, and is even popular today due to appeals of energy saving and health. However, most of the bikes generally available in the market are of fixed type and prevent easy handling and/or storage when not used, thus to frustrate the fun of riding on a bike by the consumers. Foldable bikes of the prior art are known for complicate structure and difficult operation, making them very inconvenient in use.

### SUMMARY OF THE INVENTION

The primary purpose of the present invention is to provide a bike allowing fast folding to reduce its size for carrying along, handling or storage when not used. To achieve the purpose, a bracket is provided at where appropriately on a head tube to connect to a crossbar, and another bracket is provided at where appropriately on the crossbar to connect to a seat stay; so that both of the crossbar and the seat stay expand outwardly for riding, and are folded forwardly with the respective bracket as a support.

A hydraulic cylinder is provided at where between the head tube and a seat pole; and an absorber, between the crossbar and the seat stay. A fast releaser is each respectively provided to the hydraulic cylinder and the absorber for positioning and absorption purposes during the riding of the bike.

A curve stem connected to the top of the head tube is made mobile for adjusting an optimal range between the handle and the seat depending on the individual rider.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a schematic view showing that the preferred embodiment of the present invention is in use for riding.

FIG. 3 is another schematic view showing that the preferred embodiment of the present invention is in use for riding.

FIG. 4 is a side view of the preferred embodiment of the present invention.

FIG. 5 is a schematic view showing that the preferred embodiment of the present invention is folded for handling and storage.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

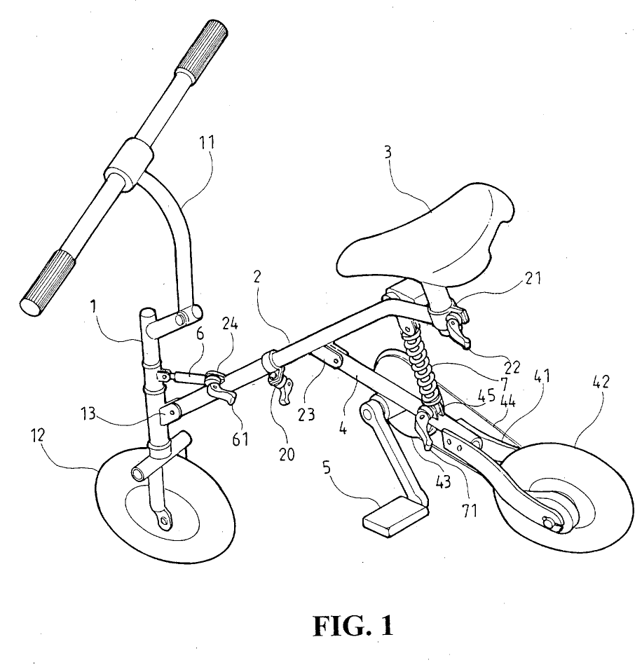

Referring to FIG. 1, a preferred embodiment of the present invention is essentially comprised of a head tube 1, a mobile and curve stem 11 is provided at the top of the head tube 1 and a front wheel 12 is connected to the lower end of the head tube 1. A bracket 13 is provided at where appropriately on head tube 13 to connect to a crossbar 2 and a fast releaser 20 is provided at where appropriately on the crossbar 2 for the crossbar to be retractable.

The crossbar 2 indicates a rising status with its terminal bending downward to be provided with an open sleeve 21. A fast releaser 22 is provided to the sleeve 21 to adjust by fixing or releasing the fast releaser 22 the height of a seat 3 inserted into the sleeve 21. A bracket 23 is provided to where below the crossbar 2 to connect to a seat stay 4. A chain stay 41 is further connected to the terminal of the seat stay 4 to mount a rear wheel 42, and a chain plate 43 is provided at where appropriately on the seat stay 4 to be pivoted to a pair of pedals 5 for controlling the turning of the rear wheel 42 through a chain 44.

A hydraulic cylinder 6 is provided between the head tube 1 and the crossbar 2, and another fast releaser 61 is provided at the bottom of the hydraulic cylinder 6. The hydraulic cylinder 6 is fixed to or released from a bracket 24, which is provided on the crossbar 2, by operating the fast releaser 61. An absorber 7 is connected to where between the straight section of the crossbar 2 and the chain stay 4, and a fast releaser 71 is provided at the bottom of the absorber 7 to fix the absorber 7 in position or release from a bracket 45.

The bike is in ready for riding when both of the crossbar 2 and the chain stay 4 respectively expand outwardly with the brackets 13, 23 as supports to fix both of the hydraulic cylinder 6 and the absorber 7 in position. When the bike is not used, both of the hydraulic cylinder 6 and the absorber 7 are released, and both of the crossbar 2 and the chain stay 4 are folded forwardly to facilitate handling and storage.

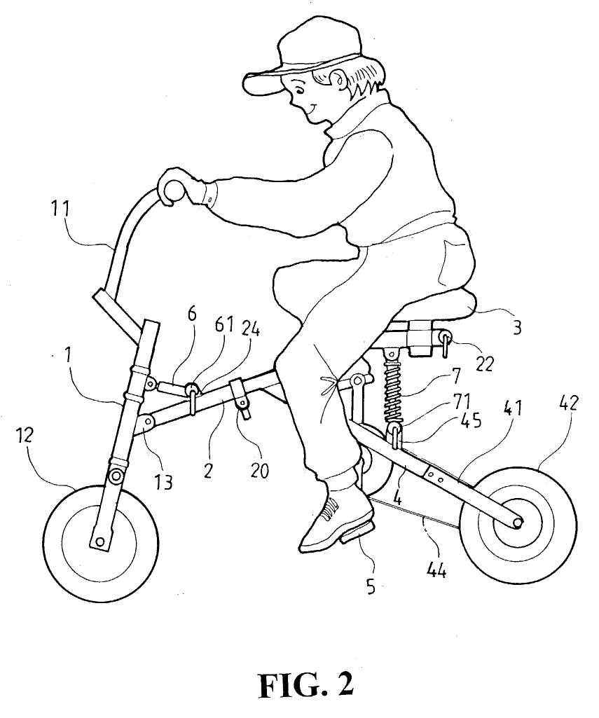

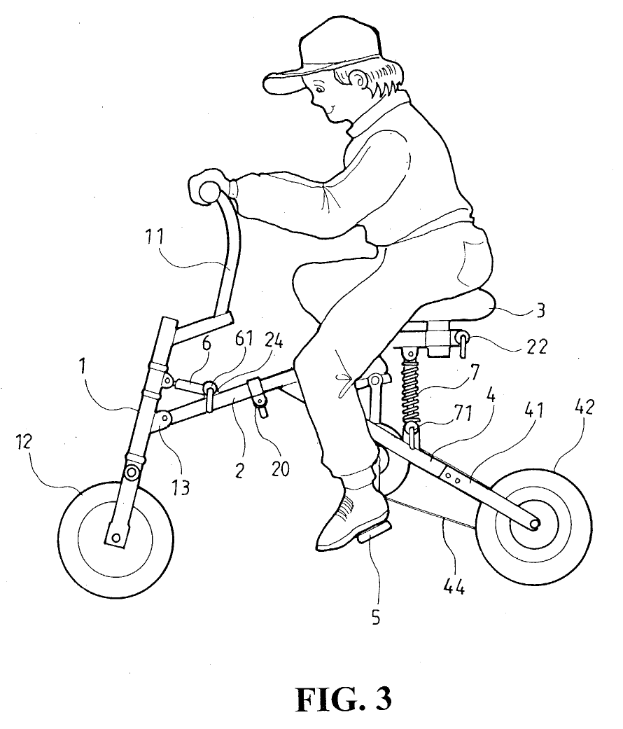

Now referring to FIGS. 2 and 3, both of the crossbar 2 and the chain stay 4 are pulled outwardly with those brackets 13, 23 as supports for riding. Meanwhile, both of the hydraulic cylinder 6 and the absorber are fixed in position for a rider to sit on the seat and step on the pedals 5 to ride the bike. Depending on the size of the individual rider, the stem 11 is turned forwardly or backwardly and the fast releaser 20 is released to extend or shorten the length of the crossbar 2 to adjust for a proper spacing between the stem 11 and the seat 3. Comfort riding is guaranteed by the buffering executed by the hydraulic cylinder 6 and the absorber 7.

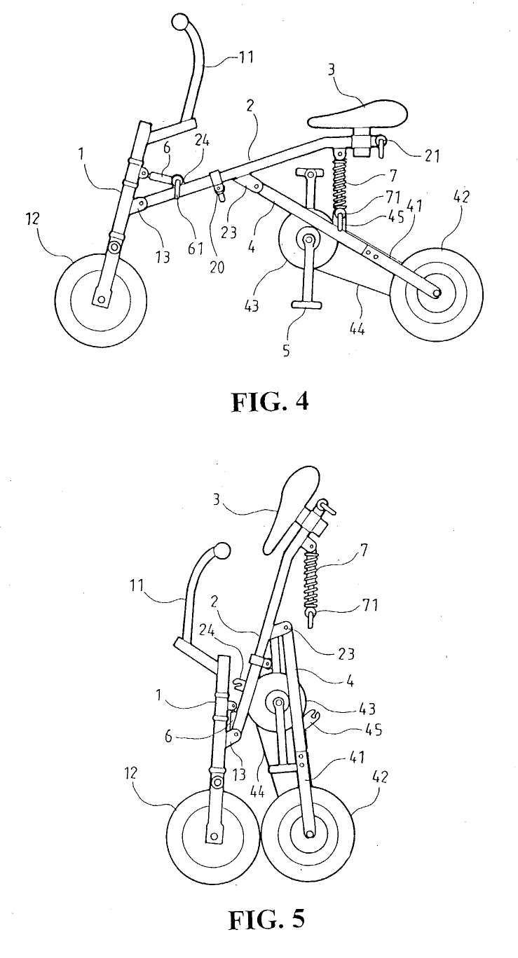

As illustrated in FIGS. 4 and 5, when the bike is not used, both of the hydraulic cylinder 6 and the absorber 7 are respectively released by operating the fast releasers 61, 71; the crossbar is folded up and forwardly with the bracket 13 as the support while the chain stay 4 is folded down and forwardly with the bracket 23 as the support for the entire bike to indicate a reverse N-shape to reduce its size for easier handling and storage.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A foldable bike comprising:
a head tube, provided at its top a stem connected to a pair of handlebars, and at its lower end a bracket to connect to a crossbar, the crossbar in rising status to connected to the bracket from the head tube having a straight section and curved terminal;
a sleeve being provided on the straight section to fix a seat in position;
a bracket being provided at the bottom to connect to a chain stay, and the chain stay, descending to connect to the bracket from the crossbar; and
a chain plate being provided at where appropriately to connect to a pair of pedals;
characterized by that when the bike is not used, both of the cross bar and the chain stay are respectively folded upwardly and downwardly to facilitate handling and storage.

2. A foldable bike as claimed in claim 1, wherein, a hydraulic cylinder and an absorber are respectively provided between the head tube and the seat pole, and the straight section of the crossbar and the chain stay; both of the hydraulic cylinder and the absorber being respectively fixed with a fast releaser to exercise the function of absorption; or respectively released from the fast releaser to facilitate folding of the bike.
